(19) United States
(12) Patent Application Publication
(10) Pub. No.: US 2017/0162313 A1
(43) Pub. Date: Jun. 8, 2017

(54) WOUND IRON CORE AND METHOD FOR MANUFACTURING WOUND IRON CORE

(71) Applicant: TOSHIBA INDUSTRIAL PRODUCTS & SYSTEMS CORPORATION, KANAGAWA (JP)

(72) Inventors: Hiromu SHIOTA, Mie (JP); Tsuyoshi MASUDA, Mie (JP); Yoshinori YAMAZAKI, Mie (JP); Eiji SHIMOMURA, Mie (JP)

(73) Assignee: TOSHIBA INDUSTRIAL PRODUCTS & SYSTEMS CORPORATION, KANAGAWA (JP)

(21) Appl. No.: 15/325,634

(22) PCT Filed: May 11, 2015
(86) PCT No.: PCT/JP2015/063461

§ 371 Date: Jan. 11, 2017

(30) Foreign Application Priority Data
Jul. 11, 2014 (JP) 2014-143135
Sep. 10, 2014 (JP) 2014-184183

(51) Int. Cl. H01F 27/24; H01F 41/02

(52) U.S. Cl. CPC H01F 27/24; H01F 41/0206

(57) ABSTRACT

A wound iron core according to an embodiment of the present invention is provided with an iron core main body part around which a plurality of iron core materials are wound, and a window part formed at the center of the iron core main body part. The iron core materials each have a cut part at least at one location per winding. The cut parts are disposed so as to be dispersed in the periphery of the window part.

### TECHNICAL FIELD

An embodiment of the present invention relates to a wound iron core in which a plurality of iron core materials are wound and a method of manufacturing the wound iron core.

### BACKGROUND ART

Recently, energy-saving and efficiency improvement have been strongly promoted as found in a so-called top-runner system which is applied in Japan as a dominant technical trend in small-sized transformer for power distribution, for example, and in establishment of standards for higher efficiency on a worldwide basis, for example. Particularly, efforts for reducing a no-load loss, which is a power loss generated in an iron core or a so-called “iron loss”, have been made all over the world, and manufacturers are fiercely competing with each other for improvement of the iron core material or improvement of an iron core structure. Here, as an iron core for a transformer, a laminated iron core in which thin cut silicon steel sheets are laminated and a wound iron core in which a thin cut silicon steel sheet is wound are known. Since a flow of a magnetic flux in the iron core is not easily interrupted in the wound iron core, it is more advantageous than the laminated iron core in terms of reduction of the iron loss.

Patent Literature 1, for example, discloses a typical constitution example of such wound iron cores. This type of wound iron core generally has the following constitution. That is, an iron core material is taken up by a circular winding die from a thin cut silicon steel sheet while being cut per winding, that is, by each turn. After that, a molding die is placed and pressed onto an inner side and an outer side of the wound iron core material, whereby a substantially rectangular iron core window is formed at a center. In the wound iron core manufactured as above, a cut part is formed at a joint of both end portions of each of the iron core materials. By arranging the cut parts while sequentially shifting them in steps in a circumferential direction of the iron core material, the flow of the magnetic flux can be made smooth, whereby magnetic resistance of a magnetic path is lowered, and an increase of the iron loss is suppressed.

### CITATION LIST

Patent Literature

Patent Literature 1: Japanese Patent Laid-Open No. 2001-284136

### SUMMARY OF INVENTION

### Technical Problem

A gap can easily occur at the cut part of each of the iron core materials, and such gaps have only magnetic permeability of air. Thus, the magnetic flux cannot easily pass the gap part and most of the magnetic flux flows by bypassing the gap. Thus, magnetic flux density can easily increase in the vicinity of the gap, whereby the iron loss in the vicinity of the gap tends to extremely increase. The iron loss which is a loss generated in the iron core material has a correlation with the magnetic flux density, and it is confirmed that the iron loss increases by substantially a square of the magnetic flux density in a region with high magnetic flux density, for example.

This embodiment provides a wound iron core that can suppress an increase of the magnetic flux density in the vicinity of the gap in the iron core material and a method of manufacturing the wound iron core.

### Solution to Problem

A wound iron core according to this embodiment includes an iron core main body part around which a plurality of iron core materials are wound and a window part formed at a center of the iron core main body part. The iron core materials have a cut part at least at one location per winding. The cut parts are disposed so as to be dispersed in a periphery of the window part.

A method of manufacturing a wound iron core according to this embodiment is a method of manufacturing a wound iron core which includes the iron core main body part around which a plurality of iron core materials are wound and a window part formed at a center of the iron core main body part, the iron core material having a cut part at least at one location per winding, and the wound iron core is wound so that the cut parts are disposed so as to be dispersed in a periphery of the window part.

### BRIEF DESCRIPTION OF THE DRAWINGS

FIG. 1 conceptually explains this embodiment and is a view illustrating a part of a wound iron core in an enlarged manner.

FIG. 2 is a view illustrating a constitution example of the wound iron core according to a first embodiment.

FIG. 3A is a view illustrating an example of a method of manufacturing the wound iron core (No. 1).

FIG. 3B is a view illustrating an example of the method of manufacturing the wound iron core (No. 2).

FIG. 3C is a view illustrating an example of the method of manufacturing the wound iron core (No. 3).

FIG. 3D is a view illustrating an example of the method of manufacturing the wound iron core (No. 4).

FIG. 4 is a view illustrating a constitution example of a wound iron core according to a second embodiment.

FIG. 5 is a view illustrating a constitution example of a wound iron core according to a third embodiment.

FIG. 6 is a view illustrating an example of the method of manufacturing the wound iron core.

FIG. 7 is a view illustrating a constitution example of a wound iron core according to a fourth embodiment.

FIG. 8 is a view illustrating a part of the wound iron core according to a variation in an enlarged manner.

FIG. 9 is a view illustrating a prior-art wound iron core.

FIG. 10 is a view illustrating a part of the prior-art wound iron core in an enlarged manner.

### DESCRIPTION OF EMBODIMENTS

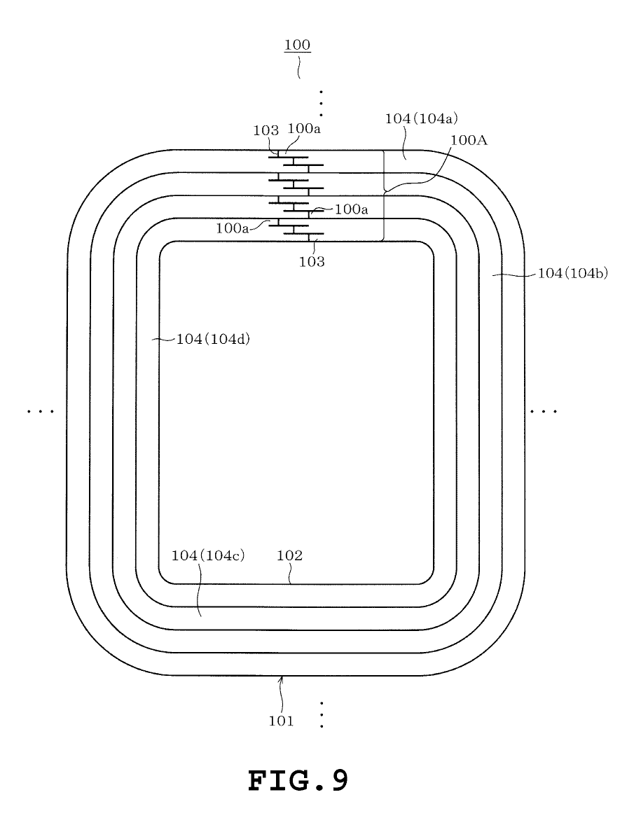

A plurality of embodiments according to a wound iron core and a method of manufacturing the wound iron core will be described below by referring to the attached drawings. Before describing this embodiment, a prior-art wound iron core will be referred to. That is, in a prior-art wound iron core 100 exemplified in FIG. 9, a plurality of iron core materials 100a are wound so as to constitute an iron core main body part 101. The wound iron core 100 has a substantially rectangular window part 102 at a center of the iron core main body part 101. Each of the iron core materials 100a has a cut part 103 at least at one location per winding. This cut part 103 is a part which becomes a joint between both end portions of each of the iron core materials 100a.

In this case, in the wound iron core 100, three iron core materials 100a form each of iron core material groups 104a, 104b, 104c, and 104d. That is, one iron core material group 104 is formed each time a predetermined number of iron core materials 100a are laminated from an inner side which is the closest to the window part 102. Moreover, the plurality of iron core materials 100a included in each of the iron core material groups 104 are wound so that the respective cut parts 103 are located while shifting in steps from each other in a circumferential direction.

Moreover, a position in the circumferential direction of each of the plurality of cut parts 103 included in one iron core material group 104 and a position in the circumferential direction of each of the plurality of cut parts 103 included in another iron core material group 104 adjacent to the iron core material group 104 substantially or perfectly match each other. That is, the wound iron core 100 has a constitution that a position of the cut part 103 returns to the same position for each of the plurality of iron core materials 100a constituting the iron core material group 104 and is repeated.

Moreover, in the wound iron core 100, four of the iron core material groups 104a, 104b, 104c, and 104d constitute a first hand 100A. The wound iron core 100 becomes a wound iron core having a size according to an application by providing a second hand, a third hand, . . . on an outer side of this first hand 100A.

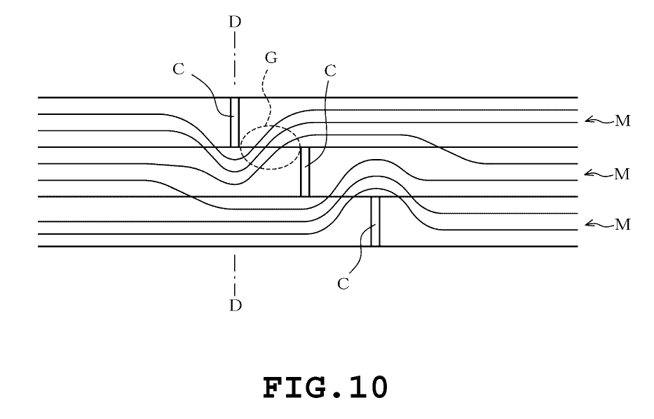

Here, a problem of this type of structure such as the prior-art wound iron core will be referred to. That is, as illustrated in FIG. 10, for example, assuming that the number of iron core materials M per hand is three and illustrating a magnetic flux flowing through one iron core material M by two magnetic flux lines, six magnetic fluxes flow through one hand. In the vicinity of a cut part C of the iron core material M, the magnetic flux flows so as to bypass a gap of the cut part C, and the six magnetic fluxes flow through the two iron core materials M in a section D of the iron core main body part including the gap. Thus, magnetic flux density in the vicinity of the gap of the cut part C increases by 3/(3−1) times, that is, approximately 1.5 times, which extremely increases an iron loss in the vicinity of the gap. The magnetic flux density in the vicinity of the gap of the cut part C in the iron core material M can be acquired by the following equation, assuming that the number of the iron core materials per hand is “n”:

Magnetic flux density=n/(n−1)

Moreover, between the cut parts C of each of the iron core materials M, or in other words, in a region G between the gaps of each of the iron core materials M, the magnetic flux density of the magnetic fluxes passing through the region G increases as the magnetic fluxes bypass the gap. Thus, an eddy current generated by the passing magnetic fluxes increases in the region G, and the generated iron loss also increases with that.

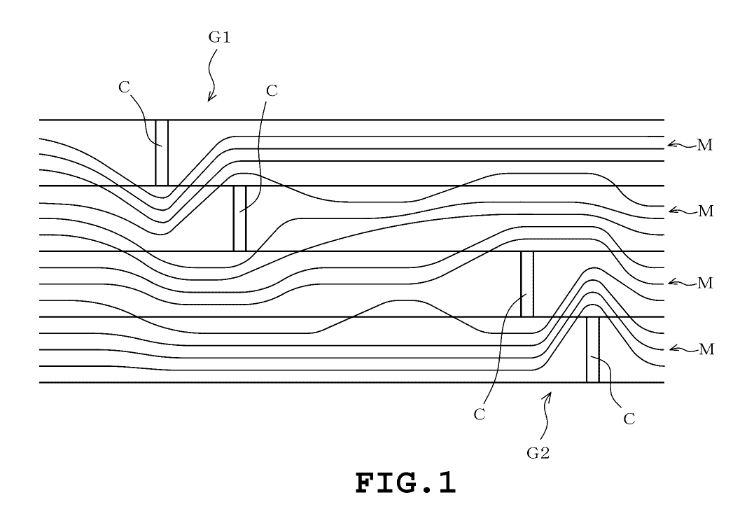

Thus, in this embodiment, a problem in such prior-art constitution is solved by an innovative technical idea illustrated below. That is, as illustrated in FIG. 1, for example, the number of iron core materials M per hand is increased than before. Then, the cut parts C of the plurality of iron core material M included in the one hand are dispersed. At this time, the cut parts C are disposed so as to be dispersed in a periphery of the window part of the wound iron core. In FIG. 1, for convenience of explanation, the magnetic fluxes flowing through the one iron core material M are illustrated by three magnetic flux lines, but a magnetic flux amount flowing through the one iron core material M is assumed to be the same as before.

According to this embodiment, the magnetic flux density in the vicinity of the gaps of the cut parts C can be suppressed to 4/(4−1) times, that is, approximately 1.33 times, whereby the iron loss in the vicinity of the gap can be made smaller.

Moreover, according to this embodiment, the four cut parts C included in the one hand are divided into two cut-part groups G1 and G2 each constituted by two cut parts C, and each of the cut-part groups G1 and G2 is dispersed so as to be disposed in different side parts of the wound iron core. As a result, one cut-part group can be accommodated in one side part of the wound iron core and thus, the iron loss can be reduced without being restricted by a length of each side of the window part.

Subsequently, a plurality of embodiments according to the wound iron core to which the technical idea of this embodiment is applied will be exemplified.

### First Embodiment

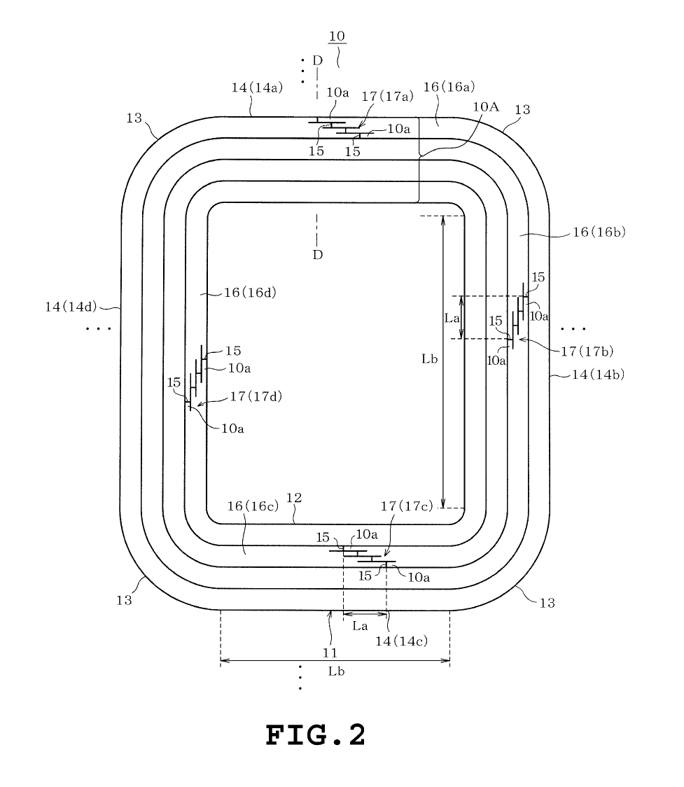

The wound iron core 10 exemplified in FIG. 2 is constituted by a plurality of iron core materials 10a obtained by cutting a metal sheet such as a silicon steel sheet, for example. The wound iron core 10 constitutes an iron core main body part 11 by winding the plurality of iron core materials 10a. The wound iron core 10 has a substantially rectangular window part 12 at a center of the iron core main body part 11. The wound iron core 10 has four corner parts 13 and four side parts 14 connecting these corner parts 13 to each other. In this case, the side parts 14 have short side parts 14a and 14c and long side parts 14b and 14d longer than these short side parts 14a and 14c. The short side parts 14a and 14c face each other with the window part 12 interposed therebetween. The long side parts 14b and 14d face each other with the window part 12 interposed therebetween.

The wound iron core 10 is used as an iron core for a transformer and the like by assembling a coil, not shown, to the long side parts 14b and 14d. The plurality of iron core materials 10a constituting the wound iron core 10 are obtained by cutting from the silicon steel sheet per winding, that is, by each turn and thus, in this case, they have one cut part 15 at each winding. This cut part 15 is a portion which becomes a joint between both end portions of each of the iron core materials 10a. And a gap can be formed easily at a portion where the cut part 15 is formed in each of the iron core materials 10a, that is, at the joint of the both end portions of each of the iron core materials 10a.

This wound iron core 10 has a constitution in which iron core material groups 16a, 16b, 16c, and 16d are formed at each predetermined number of, or in this case, four iron core materials 10a. That is, one iron core material group 16 is formed each time the predetermined number of the iron core materials 10a are laminated from an inner side which is the closest to the window part 12 side. The number of the iron core materials 10a forming one iron core material group 16 can be changed as appropriate. Moreover, the number of the iron core materials 10a forming each of the iron core material group 16 may be made different from each other as appropriate.

Moreover, the plurality of iron core materials 10a included in each of the iron core material groups 16 are wound so as to be located in steps so that each of the cut parts 15 are shifted from each other in the circumferential direction. Moreover, the iron wound iron core 10 constitutes a first hand 10A by the four iron core material groups 16a, 16b, 16c, and 16d. And by providing a second hand, a third hand, . . . on an outer side of this first hand 10A, the wound iron core 10 becomes a wound iron core having a size according to the application.

The wound iron core 10 has a constitution in which the plurality of cut parts included in one hand are dispersed in a periphery of the window part 12. That is, the wound iron core 10 has a constitution in which a cut-part group 17 constituted by a plurality of the cut parts 15 included in one iron core material group 16 and a cut-part group 17 constituted by a plurality of the cut parts 15 included in another iron core material group 16 are disposed so as to be dispersed in the periphery of the window part 12. In this case, a cut-part group 17a of the iron core material group 16a is located on the one short side part 14a, a cut-part group 17b of the iron core material group 16b is located on the one long side part 14b, a cut-part group 17c of the iron core material group 16c is located on the other short side part 14c, and a cut-part group 17d of the iron core material group 16d is located on the other long side part 14d. That is, each of the cut-part groups 17a to 17d is disposed so as to be dispersed in each of the side parts 14a to 14d different from each other.

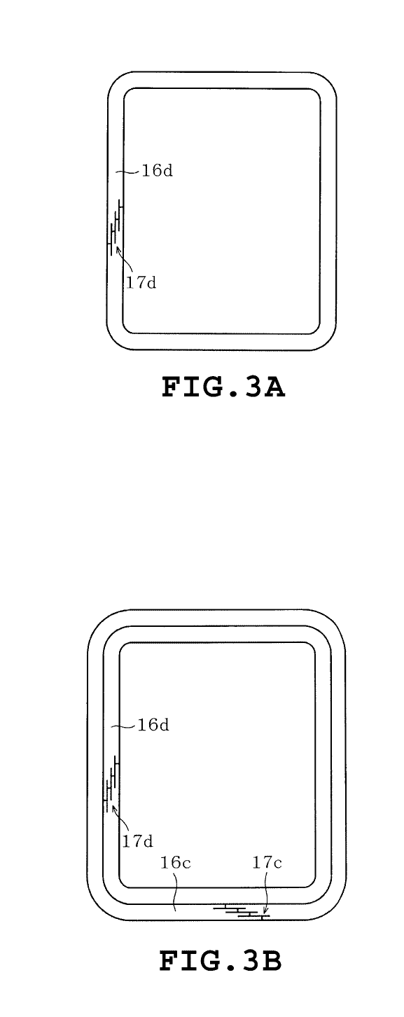

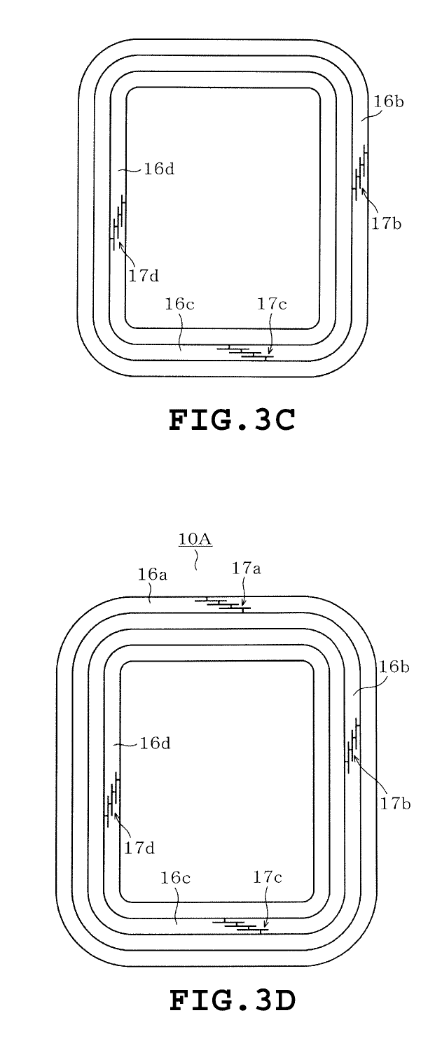

Subsequently, one example of the method of manufacturing the wound iron core 10 will be described. That is, as exemplified in FIG. 3A, the iron core material group 16d is formed by sequentially winding the plurality of iron core materials 10a. At this time, each of the iron core materials 10a is wound so that the cut-part group 17d constituted by the plurality of cut parts 15 is located on the long side part 14d. Subsequently, as illustrated in FIG. 3B, on the outer side of the iron core material group 16d, the plurality of iron core materials 10a are sequentially wound so as to form the iron core material group 16c. At this time, each of the iron core materials 10a is wound so that the cut-part group 17c constituted by the plurality of cut parts 15 is located on the short side part 14c.

Subsequently, as exemplified in FIG. 3C, on the outer side of the iron core material group 16c, the plurality of iron core materials 10a are sequentially wound so as to form the iron core material group 16b. At this time, each of the iron core materials 10a is wound so that the cut-part group 17b constituted by the plurality of cut parts 15 is located on the long side part 14b. Subsequently, as exemplified in FIG. 3D, the plurality of iron core materials 10a are sequentially wound on the outer side of the iron core material group 16b so as to form the iron core material group 16a. At this time, each of the iron core materials 10a is wound so that the cut-part group 17a constituted by the plurality of cut parts 15 is located on the short side part 14a. As described above, the first hand 10A is provided by sequentially winding the iron core materials 10a so that the cut-part groups 17a to 17d are disposed in the periphery of the window part 12, or in other words, so as to be dispersed on each of the side parts 14a to 14d. Then, by further providing the second hand, the third hand, . . . as necessary, the wound iron core 10 having the size according to the application is manufactured.

According to the wound iron core 10 according to this embodiment, on each of the side parts 14 including each of the cut-part groups 17, assuming that the magnetic flux flowing through the one iron core material 10a is indicated by two magnetic flux lines, for example, 32 magnetic fluxes per hand flow through 15 iron core materials 10a. Thus, the magnetic flux density in the vicinity of the gap of the cut parts 15 can be suppressed to 16/(16−1) times, that is, to approximately 1.06 times. Therefore, the iron loss in the vicinity of the gap can be made smaller.

Moreover, according to the wound iron core 10, since the cut parts 15 are dispersed in the periphery of the window part 12, a whole length La of the cut-part groups 17 disposed on each of the side parts 14, that is, the length La between the cut part 15 of the first iron core material 100a and the cut part 15 of the last iron core material 100a forming each of the cut-part groups 17 does not become longer. Therefore, an effect similar to that of the case where the number of the iron core materials 10a constituting substantially one iron core material group 16 is increased can be obtained without being restricted by a length Lb of one side of the window part 12.

Moreover, according to the wound iron core 10, a distance between the cut parts 15 of each of the iron core materials 10a, or in other words, between the gaps of each of the iron core materials 10a is not made larger. Thus, in this regard, too, the magnetic flux density can be suppressed without making the whole length La of the cut-part group 17 longer or without being restricted by the length Lb of the one side of the window part 12.

### Second Embodiment

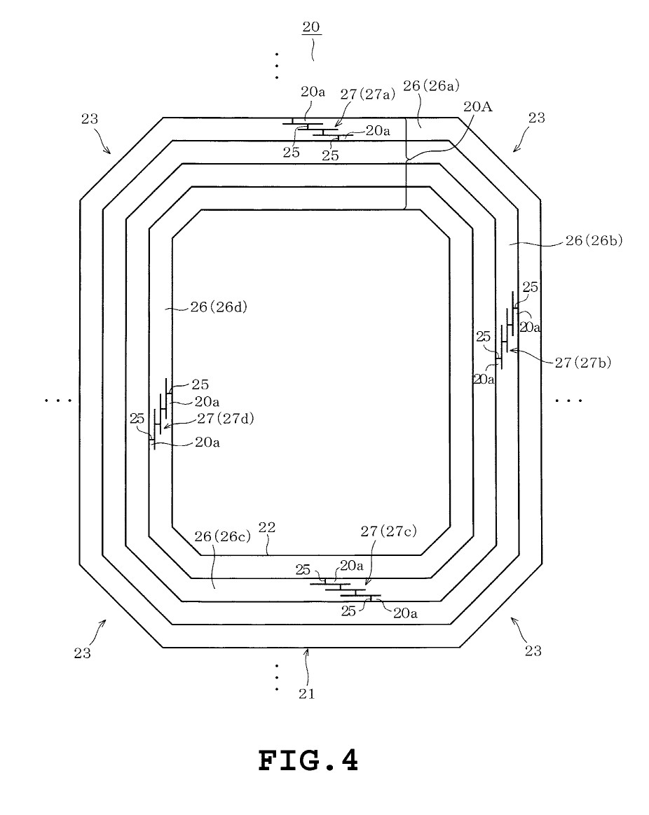

A wound iron core 20 exemplified in FIG. 4 includes an iron core main body part 21 around which a plurality of iron core materials 20a are wound and a window part 22 formed at a center of this iron core main body part 21. Moreover, in the wound iron core 20, a plurality of iron core material groups 26b to 26d are formed by a predetermined number of the iron core materials 20a, and each of the iron core material groups 26b to 26d has cut-part groups 27b to 27d, each constituted by a plurality of cut parts 25. Moreover, the wound iron core 20 constitutes a first hand 20b by the four iron core material groups 26a to 26d. Then, by further providing a second hand, a third hand, . . . on an outer side of this first hand 20A, the wound iron core 20 becomes a wound iron core having a size according to the application. The wound iron core 20 has a constitution in which the plurality of cut parts included in one hand are dispersed in a periphery of the window part 22. That is, the wound iron core 20 has a constitution in which the cut-part group of one iron core material group and the cut-part group of another iron core material group are disposed so as to be dispersed in the periphery of the window part 22.

This wound iron core 20 is constituted by bending a portion forming a corner part 23 in each of the iron core materials 20b at a predetermined bending position in advance and by winding those bent iron core materials 20a. The bending position of each of the iron core materials 20b is set as appropriate in accordance with a size of the wound iron core 20 to be manufactured, the number of iron core materials 20b to be wound and the like.

According to this constitution, dimensional accuracy at the corner part 23 is improved, and each of the cut parts 25 can be positioned by using each of the corner parts 23 as a reference. Therefore, the cut-part groups 27b to 27d of each of the iron core material groups 26b to 26d can be disposed so as to be dispersed with accuracy in the periphery of the window part 22. Moreover, nonconformity that a gap becomes too wide at the cut part 25 of each of the iron core materials 20b does not occur easily anymore, and an increase of the magnetic flux density can be further suppressed.

### Third Embodiment

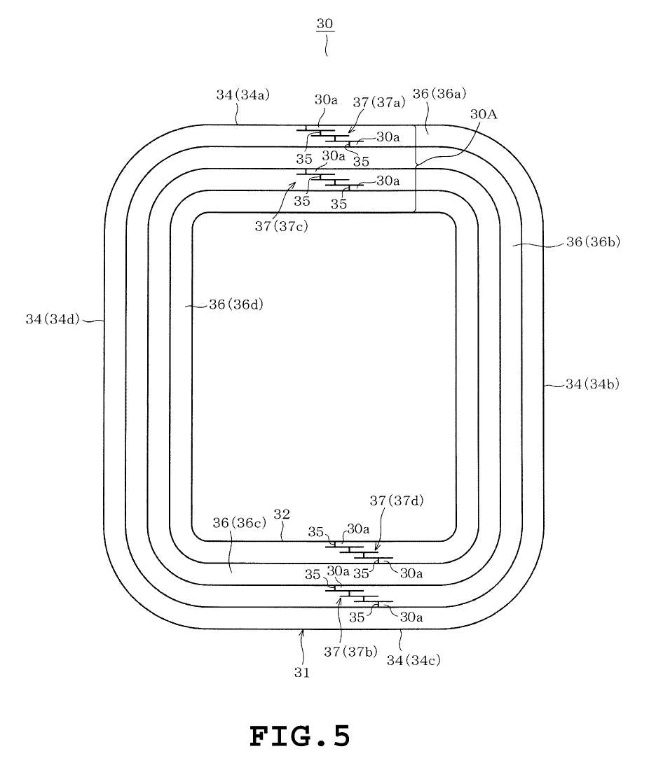

A wound iron core 30 exemplified in FIG. 5 includes an iron core main body part 31 around which a plurality of iron core materials 30b are wound and a window part 32 formed at a center of this iron core main body part 31. Moreover, in the wound iron core 30, a plurality of iron core material groups 36b to 36d are formed by a predetermined number of the iron core materials 30a, and each of the iron core material groups 36b to 36d has cut-part groups 37b to 37d, each constituted by a plurality of cut parts 35. Moreover, the wound iron core 30 constitutes a first hand 30b by the four iron core material groups 36a to 36d. Then, by further providing a second hand, a third hand, . . . on an outer side of this first hand 30A, the wound iron core 30 becomes a wound iron core having a size according to the application. The wound iron core 30 has a constitution in which the plurality of cut parts included in one hand are dispersed in a periphery of the window part 32. That is, the wound iron core 30 has a constitution in which the cut-part groups 37b to 37d of each of the iron core material groups 36b to 36d are disposed at a position alternately facing each other one by one with the window part 32 interposed therebetween. In this case, the cut-part group 37b of the iron core material group 36b is located on one short side part 34a, the cut-part group 37b of the iron core material group 36b is located on the other short side part 34c, the cut-part group 37c of the iron core material group 36c is located on the one short side part 34a, and the cut-part group 37d of the iron core material group 36d is located on the other short side part 34c. That is, in the wound iron core 30, the cut-part groups 37b and 37c are dispersed on the same side part 34a, while the cut-part groups 37b and 37d are disposed so as to be dispersed on the same side part 34c.

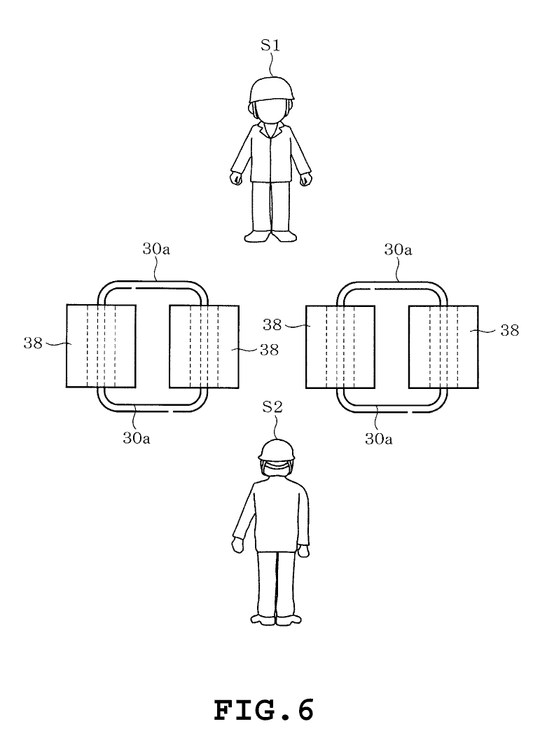

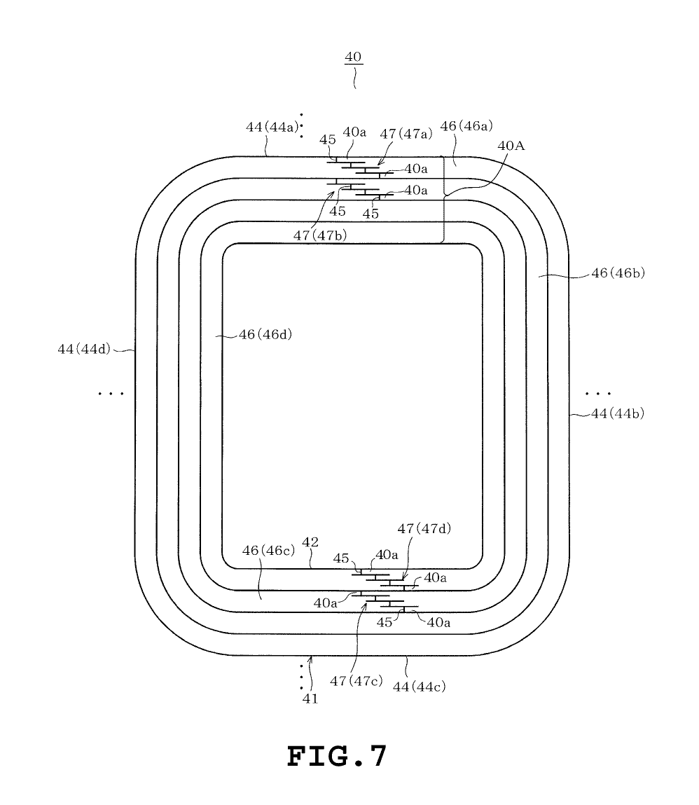

By means of this embodiment, too, an increase of the magnetic flux density in the vicinity of the gap can be suppressed as in each of the aforementioned embodiment, and the iron loss can be made smaller. Moreover, as illustrated in FIG. 6, for example, in a process of manufacturing the wound iron core 30 to which the coil 38 is assembled, two workers S1 and S2 are assigned on both sides of the coil 38 in the axial direction, and when each of the workers S1 and S2 alternately inserts the iron core material 30b into the coil 38, the wound iron core 30 to which the coil 38 is assembled can be efficiently manufactured. Moreover, by sharing the work by the worker S1 who inserts the iron core material 30b from one side of the coil 38 and the worker S2 who inserts the iron core material 30b from the other side of the coil 38, the wound iron core 30 to which the coil 38 is assembled can be manufactured in plural in a simultaneous process.

### Fourth Embodiment

A wound iron core 40 exemplified in FIG. 7 includes an iron core main body part 41 around which a plurality of iron core materials 40b are wound and a window part 42 formed at a center of this iron core main body part 41. Moreover, in the wound iron core 40, a plurality of iron core material groups 46b to 46d are formed by a predetermined number of the iron core materials 40a, and each of the iron core material groups 46b to 46d has cut-part groups 47b to 47d, each constituted by a plurality of cut parts 45. Moreover, the wound iron core 40 constitutes a first hand 40b by the four iron core material groups 46a to 46d. Then, by further providing a second hand, a third hand, . . . on an outer side of this first hand 40A, the wound iron core 40 becomes a wound iron core having a size according to the application. The wound iron core 40 has a constitution in which the plurality of cut parts included in one hand are dispersed in a periphery of the window part 42. That is, the wound iron core 40 has a constitution in which the cut-part groups 47b to 47d of each of the iron core material groups 46b to 46d are disposed at positions facing each other with the window part 42 interposed therebetween in a plurality of, or in this case by the two cut-part groups 47 each. In this case, the cut-part group 47b of the iron core material group 46b and the cut-part group 47b of the iron core material group 46b are located on one short side part 44a, while the cut-part group 47c of the iron core material group 46c and the cut-part group 47d of the iron core material group 46d are located on the other short side part 44c. That is, in the wound iron core 40, the cut-part groups 47b and 47b are dispersed on the same side part 44a, while the cut-part groups 47c and 47d are disposed so as to be dispersed on the same side part 44c.

According to this embodiment, too, an increase of the magnetic flux density in the vicinity of the gap can be suppressed similarly to each of the aforementioned embodiments, and the iron loss can be made smaller. Moreover, in a process of manufacturing the wound iron core 40 to which a coil, not shown, is assembled, by assigning two workers on both sides of the coil in the axial direction and having them alternately insert the iron core materials 40a into the coil, a plurality of the wound iron cores 40 to which the coil is assembled can be efficiently manufactured in a simultaneous process while the work is shared.

The wound iron core according to each of the embodiments described above includes an iron core main body part around which a plurality of iron core materials are wound and a window part formed at a center of the iron core main body part. The iron core materials have one cut part at least at one location per winding. The cut part is disposed so as to be dispersed in a periphery of the window part. According to this constitution, an increase of the magnetic flux density in the vicinity of the gap of the iron core material can be suppressed without being restricted by the length of the window part.

Moreover, the method of manufacturing the wound iron core according to this embodiment is a method of manufacturing a wound iron core including an iron core main body part around which a plurality of iron core materials are wound and a window part formed at a center of the iron core main body part, the iron core material having a cut part at least at one location per winding, and the wound iron core is wound so that the cut parts are disposed so as to be dispersed in a periphery of the window part. According to this manufacturing method, the wound iron core which can suppress an increase of the magnetic flux density in the vicinity of a gap of the iron core material without being restricted by a length of the window part can be manufactured.

This embodiment is presented as an example and is not intended to limit a range of the invention. These novel embodiments can be put into practice in the other various forms and are capable of various types of omission, replacement and changes within a range not departing from the gist of the invention. This embodiment and its variation are included in the range of the invention and the gist and are included in the invention described in the appended claims and its equivalent range.

For example, the iron core material is not limited to those having a cut part at one location per winding but may have a cut part at plural spots per winding. That is, as long as the iron core has a cut part at least at one location per winding, it is included in the technical idea according to this embodiment. In this case, it is assumed that a plurality of the cut parts are disposed so as to be dispersed in a periphery of a window part so that each of the cut parts is not overlapped at the same position.

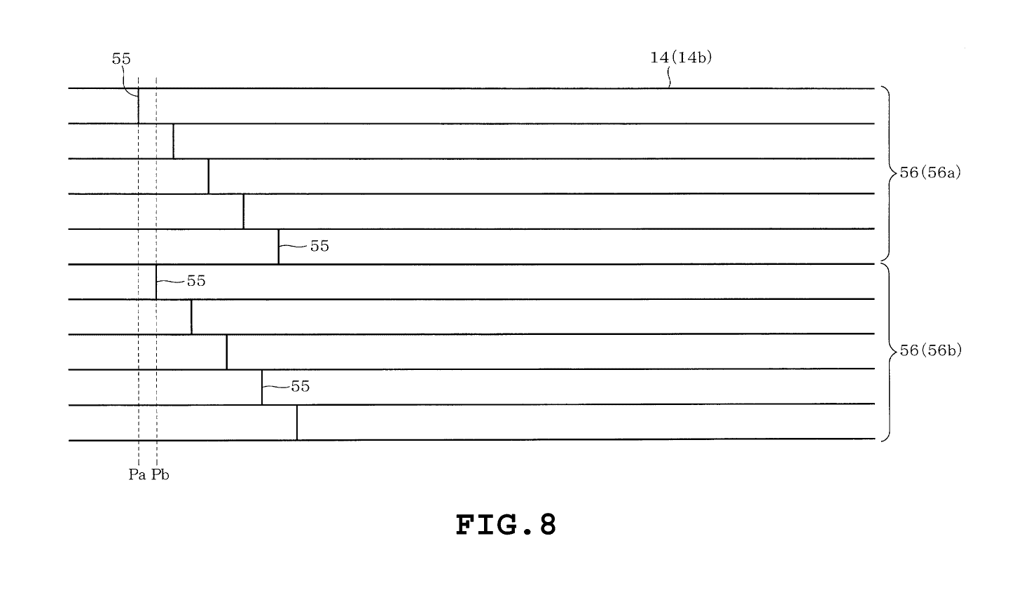

Moreover, as illustrated in FIG. 8, for example, if a position Pa of a cut part 55 included in one iron core material group 56b and a position Pb of the cut part 55 included in another iron core material group 56b are shifted in a circumferential direction of the iron core main body part even by a slight distance, an effect of suppressing the magnetic flux density in the vicinity of the one cut part 55 to n/(n−1) times can be obtained, and thus, an effect similar to those in the aforementioned embodiments can be obtained. In this case, a whole length of one cut-part group constituted by a plurality of the cut parts 55, that is, a length from the first cut part 55 included in the one iron core material group 56b to the last cut part 55 included in another iron core material group 56b is assumed not to exceed a length of one side of the window part.

### REFERENCE SIGNS LIST

wound iron core
10b iron core material
11 iron core main body part
12 window part
15 cut part
16 iron core material group
17 cut-part group
20 wound iron core
20a iron core material
21 iron core main body part
22 window part
25 cut part
26 iron core material group
27 cut-part group
30 wound iron core
30b iron core material
31 iron core main body part
32 window part
35 cut part
36 iron core material group
37 cut-part group
40 wound iron core
40a iron core material
41 iron core main body part
42 window part
45 cut part
46 iron core material group
47 cut-part group
50 wound iron core
55 cut part
56 iron core material group

1. A wound iron core comprising:
an iron core main body part around which a plurality of iron core materials are wound; and
a window part formed at a center of the iron core main body part, wherein
the iron core materials have a cut part at least at one location per winding, and the cut parts are dispersed in a periphery of the window part.

2. The wound iron core according to claim 1, wherein
an iron core material group is formed by a predetermined number of the iron core materials; and
a cut-part group constituted by a plurality of the cut parts included in one iron core material group and a cut-part group constituted by a plurality of the cut parts included in another iron core material group are dispersed in a periphery of the window part.

3. The wound iron core according to claim 1, wherein
the cut-part groups face each other with the window part interposed therebetween.

4. The wound iron core according to claim 3, wherein
the cut-part groups alternately face each other one by one with the window part interposed therebetween.

5. The wound iron core according to claim 3, wherein
the cut-part groups alternately face each other in a plurality of cut-part groups with the window part interposed therebetween.

6. The wound iron core according to claim 1, wherein
the iron core materials are wound so that the cut part is shifted in steps in a circumferential direction.

7. The wound iron core according to claim 1, wherein
the iron core materials are wound in a state where a portion forming a corner part is bent in advance.

8. A method of manufacturing a wound iron core which includes an iron core main body part around which a plurality of iron core materials are wound and a window part formed at a center of the iron core main body part, the iron core materials having a cut part at least at one location per winding, wherein
the wound iron core is wound so that the cut parts are disposed so as to be dispersed in a periphery of the window part.

9. The wound iron core according to claim 2, wherein
the cut-part groups face each other with the window part interposed therebetween.

10. The wound iron core according to claim 2, wherein
the iron core materials are wound so that the cut part is shifted in steps in a circumferential direction.

11. The wound iron core according to claim 3, wherein
the iron core materials are wound so that the cut part is shifted in steps in a circumferential direction.

12. The wound iron core according to claim 4, wherein
the iron core materials are wound so that the cut part is shifted in steps in a circumferential direction.

13. The wound iron core according to claim 5, wherein
the iron core materials are wound so that the cut part is shifted in steps in a circumferential direction.

14. The wound iron core according to claim 2, wherein
the iron core materials are wound in a state where a portion forming a corner part is bent in advance.

15. The wound iron core according to claim 3, wherein
the iron core materials are wound in a state where a portion forming a corner part is bent in advance.

16. The wound iron core according to claim 4, wherein
the iron core materials are wound in a state where a portion forming a corner part is bent in advance.

17. The wound iron core according to claim 5, wherein
the iron core materials are wound in a state where a portion forming a corner part is bent in advance.

18. The wound iron core according to claim 6, wherein
the iron core materials are wound in a state where a portion forming a corner part is bent in advance.
